(19) United States
(12) Patent Application Publication
(10) Pub. No.: US 2010/0048787 A1
(43) Pub. Date: Feb. 25, 2010

(54) WOOD STAIN COMPOSITION AND FINISHING METHOD

(75) Inventors: Ira J. Shapiro, High Point, NC (US); Timothy A. Pierce, Trinity, NC (US)

Correspondence Address: THE SHERWIN-WILLIAMS COMPANY, 101 PROSPECT AVENUE N.W., 1100 MIDLAND BLDG. - LEGAL DEPARTMENT, CLEVELAND, OH, 44115-1075, US

(73) Assignee: THE SHERWIN-WILLIAMS COMPANY, Cleveland, OH (US)

(21) Appl. No.: 12/394,728

(22) Filed: Feb. 27, 2009

Related U.S. Application Data
(60) Provisional application No. 61/032,101, filed on Feb. 28, 2008.

(51) Int. Cl. C08K 5/06

(52) U.S. Cl. 524/376

(57) ABSTRACT

A stain composition includes a stable blend of a light fast dye, a pigment, a hydrocarbon solvent, an alkyd resin, and a compatibilizer solvent. The stain composition may further include one or more oxygenated solvents in addition to the compatibilizer solvent, which may be a glycol ether solvent. The compositions of the present invention facilitate replacing, in a single tinting step, the separate dye tinting and pigment tinting steps used in conventional wood finishing schedules.

### DETAILED DESCRIPTION OF THE INVENTION

This application claims priority to U.S. Provisional Patent Application Ser. No. 61/032,101, filed on Feb. 28, 2008.

### BACKGROUND OF THE ART

Commercial finishing schedules for wood products, such as cabinetry and furniture, are conventionally multi-step processes that involve alternating applications of materials that color, tint, or highlight the wood and materials containing film forming resins that provide protection to the wood or to its underlying natural or applied coloration. In concert with the multiple applications of materials that color and protect the wood, wood finishing typically requires periods of time during which applied layers must be allowed to dry and periods of time during which applied layers are sanded and cleared of dust to facilitate subsequently applied layers.

One typical approach to finishing a wood furniture substrate may include the steps of (1) sanding the substrate followed by complete removal of sanding dust; (2) spray application of a dye stain; (3) spray application of a wash coat to seal in the dye stain and provide the perception of depth in the final appearance; (4) light sanding of the wash coat followed by complete removal of sanding dust; (5) spray application of a pigmented wiping stain followed by cleanly wiping off the excess stain; (6) spray application of a protective sealer; (7) sanding of the sealer and subsequent removal of sanding dust to yield a smooth surface; and (8) spray application of one or more topcoats to yield the desired appearance and surface protection. Thus, a typical commercial wood finishing approach may comprise eight or more discrete steps in order to achieve a desirable result.

Unfortunately, a comprehensive finishing schedule, such as described above, though it produces a desirable appearance, is time consuming to complete. The steps must be taken in proper order, with an appropriate allowance of time between steps for drying and thorough attention in sanding and dusting. Efforts to cut back on dry time allowance or sanding can produce defects in the final finish that are difficult to correct.

A better approach to improving efficiency in wood finishing processes would be to collapse processing steps. Thus, for example, it would be desirable to provide a single composition that could match the aesthetic and functional value provided by the separate dye stain, wash coat, and pigmented wiping stain, so as to replace in a single step, the multiple steps associated with application of these separate layers that is conventionally used now. Considerable time and cost savings can be anticipated with a stepwise reduction in the finishing schedule.

Thus, it is desirable to provide a solvent borne stain composition that includes a dye, a pigment and a film-forming resin. As noted above, it is common practice to finish wood with both a dye and a pigment, though in separate application steps. These two types of colorants serve distinct purposes. A dye is a solution of colorant dissolved in a carrier solvent. On application to wood, the dye is absorbed into the wood fibers. A pigment is a dispersion of colorant particles in a carrier solvent. On application to wood, the pigment particles sit on the surface or are deposited in open pores and crevasses.

One technical challenge to formulating solvent borne stain compositions that comprise both dyes and pigments, is that many dyes, particularly light fast, metal complex dyes, which are desirable to use in wood finishes, have poor solubility in hydrocarbon (aliphatic and aromatic) solvents that are conventionally used in making pigment dispersions and wiping stains. Thus, it has been an unresolved challenge to provide a solvent environment in which both the dye and pigment are stable. This challenge has been addressed in the present invention by the discovery that use of a glycol ether solvent as a compatibilizer solvent in conjunction with a light fast dye can stabilize the solubility of the dye upon addition to a solvent vehicle comprising significant levels of hydrocarbon solvents, which are amenable to pigments and pigment dispersions, and facilitate stable addition of light fast dyes in the hydrocarbon solvent vehicle in amounts that would otherwise salt out.

### SUMMARY OF THE INVENTION

Thus, the present invention provides solvent borne stain compositions that comprise both a light fast dye and at least one pigment. The stain compositions further comprise an alkyd resin, at least one hydrocarbon solvent and a compatibilizer solvent. The compositions can be applied to a wood substrate in one or more coats by any conventional means, including spraying, dipping, brushing, wiping, and ragging.

A method of finishing a wood substrate may thus comprise the step of applying to the wood substrate a stain composition according to one of the embodiments of the present invention. The stain composition may be wiped or sprayed onto the wood substrate in one or more layers. Excess stain composition may be wiped from the surface of the wood substrate. A protective sealer layer may be applied by conventional means to at least the stained portion of the substrate. A conventional topcoat may optionally be applied over the stain composition or the protective sealer layer. In some embodiments, it may be useful to sand and dust, or otherwise smooth the substrate at least prior to application of the stain composition. Additionally, it may be useful to sand and dust, or otherwise smooth the substrate following application of the sealer layer and/or topcoat layer. Substantial time and cost savings over conventional finishing techniques may be anticipated by using the compositions and methods taught herein.

According to some embodiments of the invention, a stain composition comprises:

(a) a light fast dye,

(b) an alkyd resin,

(c) at least one hydrocarbon solvent, comprising at least one hydrocarbon aliphatic solvent,

(d) a pigment,

(e) and a compatibilizer solvent, which may be a glycol ether solvent.

In some embodiments, the light fast dye may be a metal complex dye and in some embodiments, may be a solution metal complex dye. The solution metal complex dye may comprise metal complex dye solids dissolved in an oxygenated solvent, such as a ketone solvent.

The alkyd resin may be a film-forming alkyd resin. In some embodiments, the alkyd resin may be fatty acid modified polyethylene phthalate resin.

Embodiments of the invention taught herein provide a stable, solvent borne stain composition that comprises at least one metal complex dye, at least one colored pigment, and at least one film forming alkyd resin in a solvent vehicle comprising from 20 to about 60 weight percent of hydrocarbon solvents, including at least one aliphatic hydrocarbon solvent.

According to another embodiment of the invention, a stain composition may comprise:

(a) from 0.1 to about 10 weight percent of one or more light fast dyes,

(b) from 1 to about 40 weight percent of one or more alkyd resins,

(c) from 10 to about 60 weight percent of a hydrocarbon solvent blend, comprising at least one aliphatic hydrocarbon solvent,

(d) from 1 to about 40 weight percent of one or more pigments; and

(e) from 5 to about 60 weight percent of one or more oxygenated solvents, including at least one compatibilizer solvent.

The compatibilizer solvent may be a glycol ether solvent, and, in some embodiments, may be ethylene glycol monobutyl ether.

Conventional additives used in wood finishing products, including pigment dispersants, rheological modifiers, anti-skinning agents, catalysts, driers, and the like may also be used in the stain compositions taught herein.

According to another embodiment of the invention, a stain composition comprises a blend of:
(a) A dye solution comprising a dye and a compatibilizer solvent, and optionally, at least one other oxygenated solvent,
(b) A colorant vehicle, comprising an alkyd resin, at least one hydrocarbon solvent and at least one oxygenated solvent; and
(c) At least one pigment.

According to another embodiment of the invention, a stain composition comprises a blend of:
(a) A dye solution comprising a light fast metal complex dye and a glycol ether compatibilizer solvent, and optionally, at least one other oxygenated solvent,
(b) A colorant vehicle, comprising an alkyd resin, at least one hydrocarbon solvent and at least one oxygenated solvent; and
(c) At least one pigment.

According to some embodiments, the pigment may be a colored pigment, and in still other embodiments may be a pigment dispersion comprising pigment particles dispersed into an alkyd solvent.

### DETAILED DESCRIPTION OF THE INVENTION

The stain compositions of the present invention comprise a blend of at least one pigment and at least one dye stably dispersed in a solvent vehicle comprising one or more hydrocarbon solvents, including, in some embodiments, at least one aliphatic hydrocarbon solvent, and a compatibilizer solvent. The stain composition further comprises an alkyd resin.

Light fast dyes are particularly desirable to use in the stain compositions of the present invention because of their resistance to fading upon exposure to natural light. For purposes hereof, a light fast dye is a dye that has a minimum rating of 5 on the blue wool scale or 3 per DIN EN ISO 105-B01. Amongst the light fast dyes, light fast metal complex dyes are particularly useful.

Metal complex dyes may include 1:1 or 1:2 metal complexes of azo or azomethine dyes or metallised phthalocyanines, such as copper phthalocyanine or nickel phthalocyanine; as well as other 1:1 nickel complexes, 1:1 cobalt complexes, 1:1 copper complexes, 1:1 chromium complexes, 1:1 iron complexes or symmetrical or asymmetrical 1:2 cobalt complexes, 1:2 iron complexes or 1:2 chromium complexes. Suitable metal complex dyes may include those that are available commercially under the designation Neozapon® from BASF, Orasol® from Ciba-Geigy, or Savinyl® from Clariant Pigments & Additives.

Light fast dyes are available in dry (or powdered) form or in solution form, where the dry dye is pre-dissolved into a suitable solvent. Either form may be useful in the embodiments of the present invention; however, solution dyes are particularly useful because of their ready availability. Light fast dyes, and particularly metal complex dyes, demonstrate particularly good solubility in oxygenated organic solvents. For example, many commercially availably metal complex dye solutions comprise powdered dye pre-dissolved into acetone. For purposes herein, oxygenated organic solvents include alcohol, ketoalcohol, glycol ether, ketone, ester, and glycol ether ester solvents. Conversely, these dyes generally show poor solubility in hydrocarbon solvents, such as aliphatic and aromatic solvents. Metal complex dyes are particularly insoluble in aliphatic solvents. Useful dye solutions may have concentrations of up to about 15%, and in some embodiments, about 10% to about 15%. It will be understood that, if desirable, a light fast dye solution may be prepared by mixing an amount of powdered dye into a suitable solvent, rather than using pre-dissolved dye solutions.

Light fast dyes, including metal complex dyes, are available in a wide variety of colors. The stain compositions of the present invention may contain a single dye, although it may be desirable to combine more than one dye in order to achieve a particular compositional color. Though light fast dyes are particularly useful in the stain compositions of the present invention, non-light fast dyes may be used instead of or in addition to light fast dyes.

In some embodiments of the present invention, the stain compositions further comprise one or more pigments. Organic pigments, inorganic pigments, and blends thereof may be used. Examples of organic pigments include anthraquinone pigments; quinophthalone pigments; isoindoline pigments; nitroso pigments; perinone pigments; quinacridone pigments; perylene pigments; pyrropyrrol pigments; and dioxazine pigments. Example of inorganic pigment include carbon pigments such as carbon black; chromate pigments; sulfide pigments; oxide pigments; hydroxide pigments; ferrocyanide pigments; silicate pigments; phosphate pigments; and other pigments (such as cadmium sulfide and cadmium selenide). Pigments are available in a wide variety of colors, including whites, such as titanium dioxide, zinc oxide, and zinc sulfide; reds, such as cadmium sulfide, selenite, and iron oxide; yellows, such as cadmium sulfide, lead chromate, and iron oxide; greens, such as chromium oxide green; blues, such as iron, ultramarine, and cobalt blues; and blacks, such as carbon black. Pigments may also include metallic flakes and natural and synthetic inert extender pigments, for example, kaolinite, mica, calcium carbonate, silica, barium sulfate, and talc.

As with the dyes, in some embodiments, the desired compositional color may be achieved with one pigment, while in other embodiments; mixtures of two or more kinds or colors of pigments may be employed. In some embodiments, blends of inert pigments and pigments for supplying color (referred to as colored pigments) may be used. It will be recognized that pigment dispersions comprising discrete pigment particles dispersed in a carrier solvent, with or without pigment dispersants, resins, and other conventional additives, may be used and are readily commercially available.

Pigment dispersions comprising colored pigment particles dispersed in alkyds, are particularly well suited for use in the present invention. Such dispersions are available from a wide range of sources.

The stain compositions of the present invention also comprise at least one alkyd resin. The alkyd resin may be a film-forming alkyd resin. Suitable alkyd resins may be synthesized by the condensation polymerization of a dihydric or polyhydric alcohol and a polybasic acid or anhydride, and may include a fatty acid modifier. The particular method of generating the alkyd resin is not believed to be pertinent to the practice of the present invention.

Representative polyhydric alcohols useful in synthesizing the alkyd resin may include pentaerythritol, glycerol, propylene glycol, ethylene glycol, sorbitol, trimethylolethane, trimethylolpropane, dipentaerythritol, tripentaerythritol, neopentyl glycol, diethylene glycol, hexanetriol. 1,3-propanediol, 1,4-butanediol, 1,6-hexanediol, triethylene glycol, dipropylene glycol, 1,2-propanediol, 1,2-butanediol, 1,3-butanediol, 2-butyl-2-ethyl-1,3-propanediol (BEPD), hydroxypivaloyl hydroxypivalate (HPN), polyethylene glycol, polypropylene glycol, ethoxylated bisphenol-A having 2-12 ethylene oxide units, propoxylated bisphenol-A having 2-12 propylene oxide units, and the like.

Representative polybasic acids and anhydrides useful in synthesizing the alkyd resin may include phthalic acid or anhydride, isophthalic acid, terephthalic acid, maleic acid or anhydride, fumaric acid or anhydride, itaconic acid or anhydride, succinic acid or anhydride, adipic acid, azelaic acid, sebacic acid, tetrachlorophthalic anhydride, chlorendic anhydride, dimerized fatty acids, trimellitic acid or anhydride, pyromellitic acid or dianhydride, tetrahydrophthalic acid or anhydride, endomethylenetetrahydrophthalic acid or anhydride, cyclohexane dicarboxylic acid, glutaric acid, dodecane dioic acid, dimer-fatty acid and the like. Also, mixtures of the aforementioned may be used.

Suitable fatty acids or oils may be unsaturated or saturated and may include drying oils and semi drying oils such as soya oil, dehydrated castor oil, linseed oil, perilla oil, cottonseed oil, tall oil, safflower oil, fish oil and tung oil, and non-drying oils such as coconut oil, castor oil, palm oil and peanut oil, and the fatty acids derived from these oils. Other oils or fatty acids (derived from the oils) include corn oil, rapeseed oil, low eruric rapeseed oil, hempseed oil, kapok oil, wild mustard, oiticica oil, olive oil, poppyseed oil, tobaccoseed oil, argentine rapeseed oil, rubberseed oil, safflower oil, sesame oil, soybean oil, sugarcane oil, sunflower oil, teaseed oil, black walnut oil, Babassu oil, Chinese Tallow oil, Ouri-Curl oil, Palm Kernel oil, caprylic acid, caproic acid, capric acid, lauric acid, myristic acid, palmitic acid, stearic acid, and the like or mixtures thereof.

Long and medium oil alkyds, and blends of long and medium oil alkyds may be used and are particularly desirable. Alkyd resins based on soya and/or linseed oil are particularly useful, as are polyethylene phthalate resins.

The number average molecular weight (grams/mole) of the alkyd resin backbone may be at least about 1200 g/mole, and in other embodiments, at least about 1500 g/mole, and in still further embodiments, at least about 2000 g/mole. In still other embodiments, the number average molecular weight of the alkyd resins may be less than about 4000 g/mole.

The compositions of the present invention comprise at least one hydrocarbon solvent or blend of hydrocarbon solvents. The hydrocarbon solvents may be aliphatic or aromatic solvents. In some embodiments, the hydrocarbon solvent blend includes at least one aliphatic solvent. Useful aliphatic solvents include hydrogenated petroleum distillates, such as pentane, hexane, cyclohexane, petroleum naptha, heptane, VM&P naptha, 90 solvent (i.e., an aliphatic solvent with a flash point of 90° F.), mineral spirits, odorless mineral spirits, low odor base solvent, 140 solvent (i.e., an aliphatic solvent with a flash point of 140° F.) and mineral seal oil.

Suitable aromatic solvents may include benzene, toluene, cyclohexane, xylene, Aromatic 100 and the like.

The compositions of the present invention also comprise a compatibilizer solvent. It has been discovered that a particularly useful compatibilizer solvent is a glycol ether solvent, and more particularly, 2-butoxy ethanol. Other useful glycol ether solvents may include ethylene glycol monomethyl ether, ethylene glycol monoethyl ether, ethylene glycol monopropyl ether, ethylene glycol monohexyl ether, ethylene glycol mono-2-ethylhexyl ether, ethylene glycol monophenyl ether, diethylene glycol monomethyl ether, diethylene glycol monoethyl ether, diethylene glycol monopropyl ether, diethylene glycol monobutyl ether, propylene glycol monomethyl ether, propylene glycol monopropyl ether, propylene glycol, monobutyl ether, propylene glycol monophenyl ether, dipropylene glycol monomethyl ether, and the like.

The compatibilizer solvent enhances the solubility of the light fast dye(s) upon its addition into the principal solvent environment or vehicle of the stain composition, which comprises, as discussed above, high levels of hydrocarbon solvents.

The stain compositions of the present invention may comprise other alkyd compatible solvents in addition to the aliphatic hydrocarbon and glycol ether solvents specifically mentioned above. For example, as previously noted, it may be useful to use, in place of powdered dye, dye solutions comprising powdered dye pre-dissolved in a ketone solvent, such as acetone. Such dye solutions would, if used, contribute additional solvent into the stain composition. Still other solvents that may be used include other oxygenated solvents, such as alcohols, other ketones, esters, and glycol ether esters, and other aromatic hydrocarbon solvents. Useful alcohols may include methanol, ethanol, propanol, isopropanol, butanol, isobutanol, and the like, and phenols, such as meta-cresol and ortho-cresol. Useful ketonic solvents, in addition to acetone, may include methyl ethyl ketone, methyl n-butyl ketone, methyl isobutyl ketone, methyl propyl ketone, methyl n-amyl ketone, and the like. Useful ester solvents may include isobutyl acetate, n-butyl acetate, n-propyl acetate, amyl acetate and isobutyl isobutyrate. Useful glycol ether ester solvents may include ethylene glycol monomethyl ether acetate, ethylene glycol monoethyl ether acetate, ethylene glycol monobutyl ether acetate, diethylene glycol monoethyl ether acetate, diethylene glycol monobutyl ether acetate, propylene glycol monomethyl ether acetate.

A variety of other conventional additives may be included in the stain compositions, including driers and drier catalysts, such as drier metals like those based on cobalt, manganese, zirconium, zinc, and calcium; rheological additives, such as organoclay additives, inert pigments like kaolinite, mica, calcium carbonate, silica, barium sulfate, and talc; pigment dispersants; anti-settling agents; and anti-skinning agents. These additives may be used in conventional amounts.

Processing Method

In one embodiment of the invention, a stain composition may comprise, on a total weight percent basis:
(a) from about 1 to about 40 weight percent, alternatively, 1 to about 30 weight percent, alternatively still, 1 to about 20 weight percent, and alternatively still, 1 to about 15 weight percent, and alternatively still, about 5 to about 10 weight percent of an alkyd resin or blend of alkyd resins;
(b) from about 10 to about 60 weight percent, alternatively, 10 to about 50 weight percent, alternatively still about 20 to about 50 weight percent, and still further, about 20 to about 40 weight percent of a hydrocarbon solvent or blend of hydrocarbon solvents;
(c) from about 1 to about 40 weight percent, and alternatively, about 5 to about 40 weight percent, and alternatively still, about 5 to about 30 weight percent of one or more pigments,
(d) from about 0.1 to about 10 weight percent, alternatively, about 0.1 to about 5 weight percent, and still further, about 1 to about 5 weight percent of one or more dyes, and
(e) from about 5 to about 60 weight percent, alternatively about 5 to 50 weight percent, and still further, about 7 to 50 weight percent, and further still, about 10 to 45 weight percent, of one or more oxygenated solvents, including at least one oxygenated compatibilizer solvent.

Non-pigment additives, such as dispersants, wetting agents, catalysts, and the like, may comprise about 1 to about 10 weight percent of the stain composition.

The various elements of the stain composition having been described, a method of formulating the stain compositions of the present invention may comprise the steps of:
(a) preparing a compatibilized dye solution comprising one or more dyes and a compatibilizer solvent, and optionally, at least one other oxygenated solvent,
(b) preparing a colorant vehicle comprising a blend of at least one alkyd resin, at least one hydrocarbon solvent, which may be an aliphatic solvent, and at least one oxygenated solvent, and
(c) blending the compatibilized dye solution with the colorant vehicle and, optionally, one or more pigments
   The pigments may be inert pigments or colored pigments or both. The compatibilized dye solution may be blended into the colorant vehicle prior to or after addition of the pigment(s). It has been found that adding the compatibilizer solvent to the dye, prior to adding the dye into the colorant vehicle facilitates better-sustained solubility of the dye in the colorant vehicle.

Compatibilized Dye Solution

A compatibilized dye solution may be prepared by blending an amount of powdered light fast dye into a compatibilizer solvent, such as 2-butoxy ethanol. In another embodiment, a compatibilized dye solution may be prepared by blending a prepared dye solution with an amount of one or more compatibilizer solvents. The dye solution may be prepared, for example, by dissolving powdered dye into a suitable solvent, which may be an alcohol or ketone or ester solvent, or, as indicated above, some commercially available dyes are sold as solution dyes, such as, for example, Neozapon® A dye solutions available from BASF.

In one embodiment, the compatibilized dye solution may comprise from about 1 to about 10 weight percent dry dye and from about 90 to about 99 weight percent compatibilizer solvent. In another embodiment, the compatibilized dye solution may comprise from about 1 to about 10 weight percent dry dye and from about 90 to about 99 weight percent of a solvent blend comprising a compatibilizer solvent and at least one other oxygenated solvent, which may be a ketone solvent, ester solvent, or alcohol. Usefully, when using a solvent blend, the compatibilizer solvent may comprise about 20 to about 60 weight percent of the solvent blend in the compatibilized dye solution.

When using prepared or pre-dissolved liquid dyes having a dye concentration (in a suitable solvent) of greater than about 5%, and usefully between about 5% to about 15%, and in which the solvent in the liquid dye is an oxygenated solvent other than a compatibilizer solvent, a useful compatibilized dye solution may be made from a blend of compatibilizer solvent and dye solution in a volume ratio of from about 0.75 to 1 to about 2 to 1.

Colorant Vehicle

The colorant vehicle may comprise at least one alkyd resin, at least one hydrocarbon solvent, which may include at least one aliphatic solvent, at least one oxygenated solvent, and optionally, other conventional additives, such as dispersants, anti-skinning agents and the like. A particularly useful colorant vehicle may comprise one or more long or medium oil alkyds and a solvent blend comprising aliphatic and oxygenated solvents.

In one embodiment, a colorant vehicle comprises from about 1 to about 40 weight percent, alternatively 1 to 30, and still further, 1 to 20, and further still about 3 to 20 weight percent of an alkyd resin or alkyd resin blend; from about 20 to about 80 weight percent, alternatively, 30 to 70, and further still about 35 to about 65 weight percent hydrocarbon solvents, and from about 10 to about 30 weight percent oxygenated solvents. Driers and other additives, such as surfactants, wetting agents, dispersants, and the like may also be added in amounts form about 0.5 to about 10 weight percent.

It will be readily understood that the amount, type and blend ratio of solvents in the colorant vehicle may be varied based on desired characteristics of the colorant vehicle and the final composition; however, in some embodiments, the ratio of hydrocarbon solvents to oxygenated solvents may usefully be from about 3:2 to about 4:1. Aliphatic solvents may comprise from about 70 to about 95 weight percent of the hydrocarbon solvents in the colorant vehicle, or from about 40 to about 60 weight percent with respect to the total weight of solvents in the colorant vehicle.

Pigments

Any one or more of the pigments previously described may be blended into the colorant vehicle before, after or at the same time as the compatibilized dye solution(s) are added to the colorant vehicle. The pigments may be blended at one time or apportioned into the colorant vehicle at different times. Inert (non-coloring) pigments may be added to the colorant vehicle prior to coloring pigments. Pigments may be introduced as solids or in the form of pigment dispersions. Conventional pigments may be used in the present invention and are available from a wide range of sources.

In one embodiment, it may be useful to provide a stain composition that consists essentially of a blend of the clear colorant vehicle and the compatibilized dye solution. In such an embodiment, the inert pigments may be a component of the colorant vehicle, but the color of the stain composition would be supplied by the compatibilized dye solutions. Such a blend may comprise from about 70 to about 90 weight percent of the colorant vehicle and about 1 to about 30 weight percent of the compatibilized dye solution to provide a composition suitable for application to a wood substrate. However, in other, more preferable embodiments, it is contemplated that a stain composition will comprise a blend of colorant vehicle, one or more compatibilized dye solutions, and one or more pigments, including colored pigments.

The colorant vehicle may be packaged separately from the compatibilized dye solutions and colored pigments, thereby facilitating preparation of the stain composition and selective tinting of the colorant vehicle at the place of purchase or at the time or place of use. It will be readily recognized that achieving a desired color may involve the use of more than one color of compatibilized dye solution and more than one colored pigment. It would be useful to be able to selectively obtain the colorant vehicle, compatibilized dye solutions, and pigments separately to allow selective tinting and preparation of the stain composition prior to use.

Of particular import to this invention is providing compatibilized dye solutions that can be stably added to the colorant vehicle, despite the presence of hydrocarbon solvents, and, particularly aliphatic solvents, in the colorant vehicle.

Acknowledging the considerable variation in color that may be achieved by varying the relative amounts of pigment(s) and compatibilized dye solution(s), in some embodiments, it may be useful for the compatibilized dye solution to comprise up to about 25 weight percent of the stain composition and in other embodiments up to about 20 weight percent. In other embodiments, it may be useful for the pigments to comprise up to about 40 weight percent of the stain composition with the compatibilized dye solution comprising up to about 20 weight percent of the stain composition.

As previously indicated the stain compositions of the present invention may be applied to any substrate; however it is particularly useful for application to wood substrates. The stain composition may be applied to a wood substrate by any conventional means, including spray application, dipping, ragging, and brushing. Substrate preparation may include the step of sanding the substrate prior to application of the stain composition. The stain composition may be applied in one or more coats. Excess stain composition may be removed from the surface by wiping. The stain compositions are particularly well suited for spraying on and wiping off. The process of removing the excess stain by wiping can, in some embodiments, alter the final appearance of the stain composition on the substrate. It is believed that the scrubbing forces the pigment particles into the pores and crevasses of the wood and removes the pigment from the flake (areas of the substrate that do not include the pore) of the wood more so than a passive application of the stain might. However, this is not intended to limit application of the stain compositions by other suitable means. After the stain composition has been applied, a conventional sealer and/or topcoat layers may be applied. Suitable sealers and topcoat materials may include vinyl, nitrocellulose, alkyd urea, polyurethane, waterborne acrylics, and the like and are well known.

It is generally preferable that the wood substrate be sanded and dusted to achieve a smooth surface prior to application of the stain composition. However, it will be recognized that sanding is optional and that surface smoothness may be achieved by other means, including surface planing and/or scraping. Optional smoothing steps (sanding, scraping, etc.) may also be practiced following application of the sealer layer, and/or following application of the topcoat layer.

In order to better articulate and illuminate the invention, but without limiting the scope thereof, the following illustrative examples of one or more embodiments of the invention follow.

### Examples

### Example 1

### Preparation of Compatibilized Dye Solution

Yellow, black and red compatibilized dye solutions may be prepared by blending equal weight percents of solution metal complex dyes (Neozapon® A dyes from BASF) and 2-butoxy ethanol.

### Example 2

### Preparation of Colorant Vehicle

A Clear Colorant Vehicle A can be prepared according to the exemplary weight percent formulas in Table 1.

| | Wt. |
|---|---|
| Ingredient | % |
| Linseed and soya fatty acid modified polyethylene phthalate | 12.19 |
| Aliphatic solvent blend | 41.90 |
| (mineral spirits and 140 flash aliphatic naphtha) | |
| Aromatic solvent (aromatic naphtha 100 flash) | 19.83 |
| Glycol ether solvent (2-butoxy ethanol) | 7.12 |
| oxygenated solvent blend (acetone, diacetone alcohol, ortho cresol) | 17.38 |
| Surfactant (Soya lecithin and sodium dioctyl sulfosuccinate (1)) | 0.59 |
| Dispersant (2) | 0.18 |
| Methyl ethyl ketoxime | 0.43 |
| Catalyst blend (5% calcium octoate catalyst, 6% manganese | 0.38 |
| catalyst, and 6% cobalt catalyst) | |

(1) - Aerosol OT-S, available from Cytec Industries.
(2) - Anti-Terra-U, available from Byk Chemie.

An Inert Pigmented Colorant Vehicle B can be prepared according to the formulas in Table 2

| | Wt. |
|---|---|
| Ingredient | % |
| Linseed and soya fatty acid modified polyethylene phthalate | 9.32 |
| Aliphatic solvent blend | 31.14 |
| (mineral spirits and 140 flash aliphatic naphtha) | |
| Aromatic solvent (aromatic naphtha 100 flash) | 15.17 |
| Glycol ether solvent (2-butoxy ethanol) | 5.44 |
| oxygenated solvent blend (acetone, diacetone alcohol, ortho cresol) | 10.88 |
| Inert pigment (flaky magnesium silicate) | 21.78 |
| Surfactant (Soya lecithin and sodium dioctyl sulfosuccinate (1)) | 0.29 |
| Dispersant (2) | 0.28 |
| Antisettling Agent (3) | 4.89 |
| Catalyst blend (5% calcium octoate catalyst, 6% manganese | 0.28 |
| catalyst, and 6% cobalt catalyst) | |
| Methyl ethyl ketoxime | 0.53 |

(1) - Aerosol OT-S, available from Cytec Industries
(2) - Anti-Terra-U, available from Byk Chemie; Unifilm 150ACS polyamide wax dispersant, available from Troy Chemical.
(3) - Bentone 34 Gel - 9% in Naphtha, available from The Sherwin-Williams Company.

### Example 3

### Preparation of Stain Composition

A stain composition can be prepared according to the formulas in Table 3

| | Wt. |
|---|---|
| Ingredient | % |
| Clear Colorant Vehicle A from Example 2 | 48.67 |
| Antisettling Agent (1) | 2.57 |
| Compatibilized Dye Solution Blend - from Example 1 | 19.81 |
| Organic Pigment Dispersion | 4.12 |
| Inorganic Pigment Dispersion | 24.83 |

(1) - Bentone 34 Gel - 9% in Naphtha, available from The Sherwin-Williams Company

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicants' general inventive concept.

We claim

1. A stain composition comprising:
(a) a dye,
(b) an alkyd resin,
(c) at least one hydrocarbon solvent, comprising at least one aliphatic solvent,
(d) a pigment, and
(e) a compatibilizer solvent.

2. The stain composition of claim 1, wherein the dye is insoluble in the aliphatic hydrocarbon solvent.

3. The stain composition of claim 1, wherein the dye is a light fast dye.

4. The stain composition of claim 3, wherein the light fast dye is a metal complex dye.

5. The stain composition of claim 1, wherein the compatibilizer solvent is a glycol ether solvent.

6. The stain composition of claim 5, wherein the glycol ether solvent is 2-butoxy ethanol.

7. The stain composition of claim 1, wherein the alkyd resin is a fatty acid modified polyethylene phthalate resin.

8. A stain composition comprising:
(a) from 0.1 to about 10 weight percent of at least one light fast dye,
(b) from 1 to about 40 weight percent of at least one alkyd resin,
(c) from 10 to about 60 weight percent of at least one hydrocarbon solvent, comprising at least one aliphatic hydrocarbon solvent,
(d) from 1 to about 40 weight percent of at least one pigment, and
(e) from 5 to about 60 weight percent of at least one oxygenated solvent, comprising at least one compatibilizer solvent.

9. The stain composition of claim 8 comprising:
(a) from 0.1 to about 5 weight percent of at least one light fast dye,
(b) from 1 to about 20 weight percent of at least one alkyd resin,
(c) from 20 to about 50 weight percent of at least one hydrocarbon solvent blend, comprising at least one aliphatic hydrocarbon solvent,
(d) from 5 to about 30 weight percent of at least one pigment, and
(e) from 5 to about 60 weight percent of at least one oxygenated solvent, comprising at least one compatibilizer solvent.

10. The stain composition of claim 9, comprising from about 1 to about 5 weight percent of at least one light fast dye.

11. The stain composition of claim 10, wherein the light fast dye is a metal complex dye.

12. The stain composition of claim 11, wherein the compatibilizer solvent is a glycol ether solvent.

13. A stain composition comprising a blend of:
(a) a dye solution, comprising a dye and a compatibilizer solvent, and optionally, at least one other oxygenated solvent,
(b) a colorant vehicle, comprising an alkyd resin, at least one hydrocarbon solvent and at least one oxygenated solvent, and
(c) at least one pigment.

14. The stain composition of claim 13, wherein the dye is soluble in the compatibilizer solvent and substantially insoluble in the hydrocarbon solvent.

15. The stain composition of claim 13, wherein the dye is a metal complex dye.

16. The stain composition of claim 13, wherein, the dye solution comprises a solution of at least one metal complex dye dissolved in a glycol ether solvent, and, optionally, at least one other oxygenated solvent; and wherein the colorant vehicle comprises an alkyd resin, at least one hydrocarbon solvent, including at least one aliphatic hydrocarbon solvent, and at least one oxygenated solvent.

17. The stain composition of claim 16, wherein the at least one other oxygenated solvent in the dye solution is a ketone solvent.

18. The stain composition of claim 13, wherein the at least one pigment is a colored pigment dispersion.
